(19) United States
(12) Patent Application Publication
(10) Pub. No.: US 2001/0013131 A1
(43) Pub. Date: Aug. 9, 2001

(54) COMPUTERIZED ADVERTISEMENT BROADCASTING SYSTEM

(76) Inventor: HUNG-MIN WANG, HSINCHU CITY (TW)

Correspondence Address: DANIEL R MCCLURE, THOMAS KAYDEN HORSTEMEYER & RISLEY, SUITE 1500, 100 GALLERIA PARKWAY N W, ATLANTA, GA, 30339

(21) Appl. No.: 09/089,332

(22) Filed: Jun. 2, 1998

(30) Foreign Application Priority Data
Feb. 10, 1998 (TW) 87201904

(51) Int. Cl. H04N 7/16; H04N 7/173

(52) U.S. Cl. 725/100; 725/133; 725/141; 725/153

(57) ABSTRACT

A computerized advertisement broadcasting system that employs the technical conventions lay down by the motion picture expert group (MPEG). The system comprises a console and separable data memory cards, where the advertising program is stored within the data memory card in an MPEG compressed data stream format. The advertising program can be broadcast repetitively by the console Since the advertising program is stored digitally within a data memory card, programs can be changed simply by inserting a new data memory card. Furthermore, the system is assembled from a group of electronic devices. Therefore, unlike a video cassette broadcasting system that contains moving parts vulnerable to mechanical breakdown and tape wear leading to the deterioration of video image, the failure rate and maintenance cost of this system are low

### CROSS-REFERENCE TO RELATED APPLICATION

This application claims the priority benefit of Taiwan application serial no. 87201904, filed Feb. 10, 1998, the full disclosure of which is incorporated herein by reference

### BACKGROUND OF THE INVENTION

1. Field of Invention

The present invention relates to a computerized advertisement broadcasting system More particularly, the present invention relates to a computerized advertisement broadcasting system that utilizes the agreed upon technical conventions laid down by the motion picture expert group (MPEG).

2. Description of Related Art

In general, dynamic pictures are better able to attract the attention of customers than a static picture. Therefore, movie-like advertisement can market products much faster. At present, a few types of dynamic advertising products are available in the market. One type of advertising system makes use of a video cassette recorder (VCR) and a television set to broadcast advertising programs. A second type of advertising system makes use of some electronic circuitry and a displaying device composed of light-emitting diodes (LEDs) to produce advertising scenes and wordings.

FIG. 1 is a block diagram showing a conventional dynamic advertising system that utilizes a VCR and an outputting device. As shown in FIG. 1, the system is composed of two main units, namely, a videocassette recorder (VCR) 11 and an outputting device 12. In general, the outputting device 12 is a television set, and is normally placed alongside the marketed products or placed in prominent places such as shopping windows facing the street. A series of motion pictures that advertises a particular product are recorded on videotape. Later, the recorded advertising program is played back and shown on the television repetitively in order to attract potential customers. However, according to marketing experience, customers will start to lose their interest in the advertisement after they are watching the program for more than a minute. Therefore, most often advertising agency will design a commercial advertisement that runs for less than 2 minutes, and then record the same advertisement on a reel of blank tape repetitively for as long as the tape could hold. Using this arrangement, the advertising program can be played back many times running consecutively. FIG. 2 is a flow diagram showing the operation of the system as shown in FIG. 1. First, an advertising program of about a two-minute duration is produced in step 21. Then, the two minutes program is repeatedly recorded on a videocassette tape in step 22. Next, the recorded cassette tape is put into a VCR for playback in step 23. Thereafter, the user must check to see if the cassette tape has finished playing or not in step 24. If the playback has not finished, then the advertising program is continued to run, repeating step 23. Otherwise, the video cassette tape is rewound in step 25, and then step 23 is repeated over again.

FIG. 3 is a block diagram showing a second conventional dynamic advertising system that utilizes an LED display and is capable of loading and broadcasting advertisement from memory elements. The system includes an LED advertising panel 32 and a control console 31. The control console 31 comprises a microprocessor 311, an advertising program storage unit 312 and an LED driver 313, wherein the advertising program storage unit 3 12 can be an erasable programmable read only memory (EPROM), an electrically erasable programmable read only memory (EEPROM), flash memory or other non-volatile memory units. The microprocessor 311 follows the instructions of programs residing in the advertising program storage unit 312 for initializing the LED driver 313 so that the advertising program is shown on the LED-advertising panel 32. When another advertising program needs to be shown, memory elements within the advertising program storage unit 312 can be unplugged from the memory sockets inside the control console 31 and then be replaced. In general, the advertising programs include simple animated pictures with a few words contained within. Therefore, the programs are principally used for introducing products and emphasizing product characters.

However, both the first type of dynamic advertising system as shown in FIGS. 1 and 2 as well as the second type of dynamic advertising system as shown in FIG. 3 have a number of defects. The defects of the VCR type of system include:

1 The video cassette recorder uses rotating mechanical parts. Therefore, it is difficult to reduce spatial occupation of the product. Moreover, transportation, use and placement are inconvenient, and power consumption is generally high.

2. Since the videocassette recorder uses rotating mechanical parts, failure rate will be high as the advertising programs are repetitively run. Moreover, the magnetic head is under constant wear, and hence needs maintenance from time to time.

3. The video cassette tape may also be worn out due to repeated playback Therefore, image quality will deteriorate after a while.

4 After the videocassette tape has finished playing, the tape needs to be rewound before another round of playback can start. Therefore, there will be a period of intermission, while the tape is rewound with nothing on the displaying screen.

The defects for the LED advertising panel type of system include:

1 Only animated pictures with a few words can be shown No real image is displayed. Therefore, advertising effects are minimal

2. The resolution of the LED-advertising panel is poor. Therefore, fine image is difficult to display

3 The system is still large and bulky. In addition, the production cost, the maintenance cost and power consumption are still relatively high.

4 When there is a need for changing advertising program, the memory elements inside the control console still have to be replaced one by one Technical personnel often have to be employed to minimize human errors. Hence, the changing process is quite time consuming and costly.

In light of the foregoing, there is a need for a better and more convenient way of dynamic advertising system

### SUMMARY OF THE INVENTION

Accordingly, the present invention is to provide a computerized advertisement broadcasting system that follows the technical rules laid down by the MPEG, and is capable of repeatedly broadcasting an advertising program to draw customer's attention, thereby achieving marketing success. Furthermore, image quality will not deteriorate due to repetitive broadcasting.

In another aspect, this invention provides a computerized advertisement broadcasting system assembled from purely electronic devices that use a data memory card to store the advertising program. The data memory card is capable of inserting into or dismounting from the system so that advertising program can be changed with ease. Moreover, power consumption, production and maintenance costs of the system are all lowered.

To achieve these and other advantages and in accordance with the purpose of the invention, as embodied and broadly described herein, the invention provides a computerized advertisement broadcasting system. The system comprises a console and a data memory card. The console further includes a data memory card plug-in slot, a microprocessor, an MPEG decoder, a video decoder, an audio converter and a human-machine interface. Furthermore, the data memory card can be inserted into the memory card plug-in slot of the console. The data memory card includes a group of a memory card signal interface and a group of non-volatile memory that can be used for storing image data The image data is stored as a compressed bit stream in an MPEG format.

The memory card plug-in slot of the console allows coupling with or separation from data memory cards. The microprocessor is responsible for the control of the whole system, transferring the data, and activating the human-machine interface. The MPEG decoder receives the MPEG compressed data stream from the microprocessor, and then the data stream is decompressed into digital video signals and audio signals in the digital pulse code modulated (PCM) format. Then, the digital video signal is transferred to the video-coding device, and the audio signal is transferred to the audio converter. The video-coding device is capable of coding the video signals from the MPEG decoder to an analogue video signal output for transmission to a television or other displaying screens The audio converter is capable of converting the pulse code modulated (PCM) audio signals from the MPEG decoder into analogue left and right channel audio signals. Thereafter, the analogue audio signals are sent to loudspeakers directly or to loudspeakers after going through some audio signal amplification.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing a conventional dynamic advertising system that utilizes a VCR and an outputting device;

FIG. 2 is a flow diagram showing the operation of the system as shown in FIG. 1;

FIG. 3 is a block diagram showing a conventional dynamic advertising system that utilizes LED display and is capable of loading broadcasting advertisement from memory elements;

FIG. 4 is a block diagram showing a computerized dynamic advertising system according to one preferred embodiment of this invention; and

FIG. 5 is a flow diagram showing the operation of the system as shown in FIG. 4.

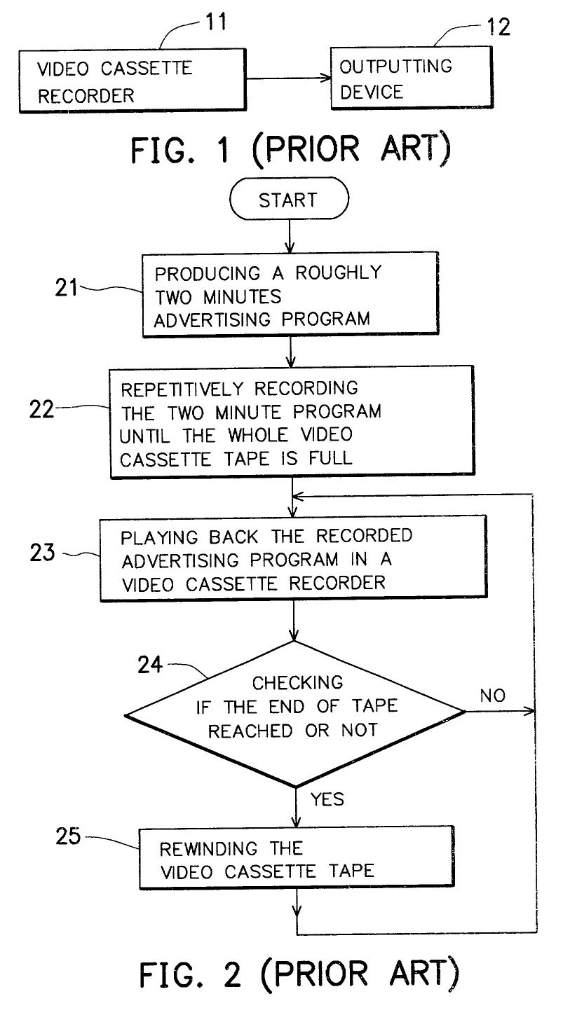

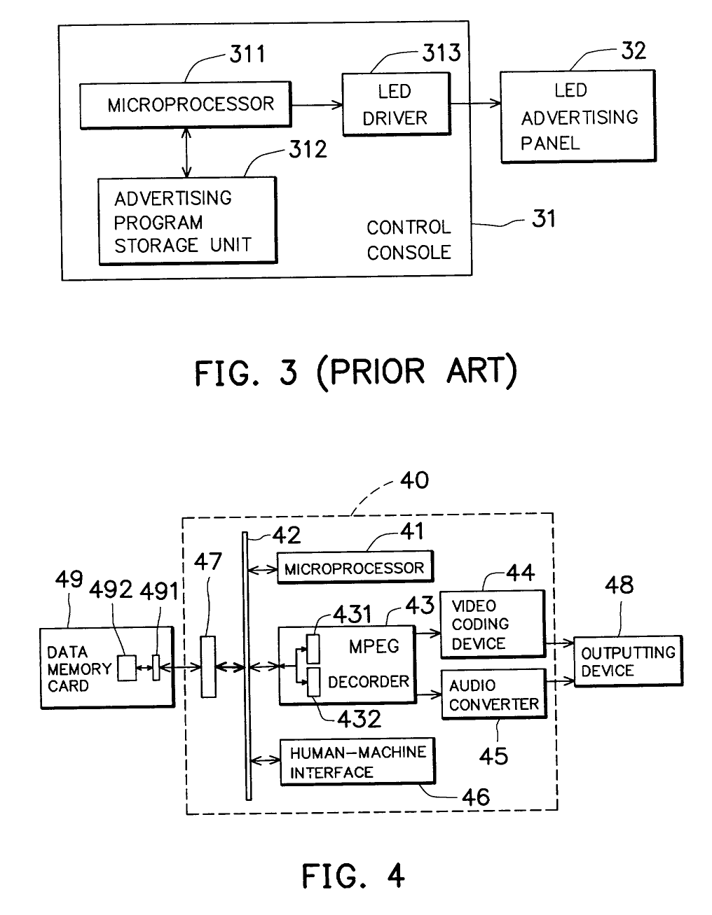

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 4 is a block diagram showing a computerized dynamic advertising system according to one preferred embodiment of this invention. As shown in FIG. 4, the computerized advertisement broadcasting system is assembled according to the technical conventions laid down by the MPEG. The system comprises a console 40 and a data memory card 49. The console 40 further includes a microprocessor 41, an MPEG decoder 43, a video coding device 44, an audio converter 45, a human-machine interface 46 and a data memory card plug-in slot 47, wherein the microprocessor 41, the MPEG decoder 43, the human-machine interface 46 and the data memory card plug-in slot 47 within the console 40 are all coupled to a signal bus 42.

The data memory card 49 can be inserted into or dismounted from the data memory card plug-in slot 47 which employs an automatic latching mechanism In other words, the data memory card 49 can be connected to or separated from the console 40, and a signal interface will provide the necessary signal coupling. The signal interface utilizes a self-determined format that includes lines for transferring data, address and control signals. In addition, one of the control lines may be used for sensing whether a data memory card 49 has been inserted into the data memory card plug-in slot 47 or not.

The data memory card 49 further includes a memory card signal interface 491 for communicating with the memory card plug-in slot interface, and banks of non-volatile memory 492. When the data memory card 49 is inserted into the data memory card plug-in slot 47, data from the non-volatile memory banks 492 can be transferred via the memory card signal interface 491 to the signal bus 42. The non-volatile memory 492 is capable of storing system parameters and digital video compressed bit stream in the MPEG format. The non-volatile memory 492 can be made from erasable programmable read only memory (EPROM), electrical erasable programmable read only memory (EEPROM), flash memory or other non-volatile memory components.

The microprocessor 41 is a controlling device for controlling the operation of the whole system. Its sphere of control includes the initialization of the system and the transfer of MPEG compressed data stream. Furthermore, the microprocessor 41 is able to detect whether a data memory card 49 has been inserted into the data memory card plug-in slot 47 or not. If the data memory card plug-in slot 47 is vacant, a pre-recorded advertising program residing in the broadcasting system is played. The pre-recorded advertising program can be anything from a general introduction of the advertising agency to an explanation of how the system should be used. On the other hand, if a data memory card 49 is present in the data card plug-in slot 47, the microprocessor 41 can pick up controlling program inside the data memory card 49 to readjust its system parameters. Thereafter, advertising program stored within the data memory card 49 can be played back as many times as required. The microprocessor 41 is also responsible for controlling the amount of compressed data stream flowing into the system, making necessary adjustments in the transfer rate so that video image and audio signals can be synchronized to the same speed. Furthermore, the microprocessor 41 is also responsible for the control of human-machine interface 46. The human-machine interface 46 can be a keyboard device, a remote control device or a display screen control device that can be operated by a user.

The MPEG decoder 43 is capable of receiving MPEG compressed data stream from the microprocessor 41, and then decompressing the compressed data stream into digital video signals and digital pulse code modulated (PCM) audio signals. The digital video signals and audio signals are sent to a video coding device 44 and an audio converter 45 respectively. The MPEG decoder 43 further includes a first-in first-out buffer 431 for the temporary storage of data and a buffer capacity indicator 432 for providing information to the microprocessor 41 about the storage capacity of the first-in first-out buffer 43 1. Hence, the transferring rate of data bit stream can be closely monitored to reflect the data transferring speed so that video image and audio sound can be synchronized and played back at a normal speed.

The video-coding device 44 is capable of receiving the digital video signals coming from the MPEG decoder 43 The digital video signals are coded into TV composite signals or S-Video signals, and then transferred to an outputting device 48. The outputting device 48 includes a video image outputting device and an audio outputting device. The video image-outputting device can be a television or other types of display screen, for example, a liquid crystal displaying screen or a monitor screen The video coding device 44 is actually a digital to analogue RGB signal converter, capable of converting the digital video signals from the MPEG decoder 43 to red, green, blue (RGB) analogue signals Therefore, RGB signals can be input directly to a displaying screen for showing the advertising program.

The audio converter 45 is capable of converting the pulse code modulated (PCM) digital audio signals coming from the MPEG decoder 43 into analogue audio signals directed to the left and right audio outputting channels of the outputting device 48, which can be a pair of loudspeakers. Alternatively, the audio signals may be amplified first before sending out to the loudspeakers.

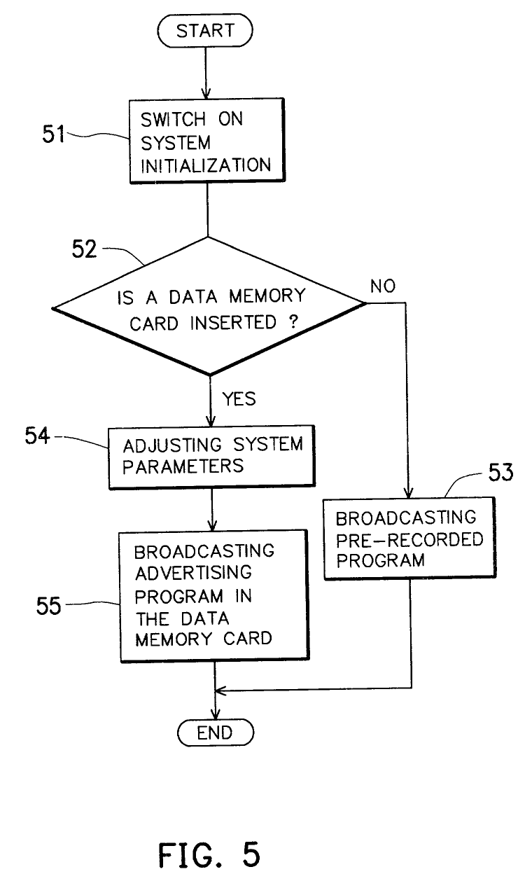

FIG. 5 is a flow diagram showing the operation of the system as shown in FIG. 4. As shown in FIG. 5, the microprocessor 41 will take control of the whole system as soon as the console is switched on in the initialization step 51 Next, condition at the data memory card plug-in slot 47 is checked to see if data memory card 49 is inserted or not in step 52 If data memory card 49 is not inserted in the memory card plug-in slot 47, step 53 is performed in which a pre-recorded advertising program is broadcast On the other hand, if a data memory card 49 is inserted into the memory card plug-in slot 47, steps 54 and 55 are executed. In step 54, a control program is retrieved from the data memory card 49, and then the system parameters are adjusted. Subsequently, in step 55, advertising program stored within the data memory card 49 is broadcast.

Using the aforementioned computerized advertisement broadcasting system, advertising programs stored inside the data memory card can be played repetitively. Moreover, changing the advertising programs is very easy. As a summary, the advantages of using this system compared with a conventional one include:

1 The whole system is assembled purely from electronic devices, and so both volume occupation and power consumption requirement are low. Because of its size reduction, transportation, operation and placement of the system are easy.

2. The whole system is assembled from electronic devices. Since there are no moving mechanical parts, there is no mechanical wear and tear. Hence, both the failure rate and the maintenance cost are low.

3 Since the images are stored digitally in a data memory card, image quality will be unaffected by repetitive broadcasting, unlike videotape recordings whose image quality can deteriorate with use.

4 Since the images are stored digitally in a data memory card, broadcasting can start from anywhere and repeated as many times as required, unlike videotape recording system whose tape has to be rewound to a definite place before re-playing. Hence, programs can be broadcast consecutively without intermission for tape rewinding.

5 Employing the MPEG format to store advertising programs enables the saving of memory space.

6. Changing advertisement programs is as simple as inserting a data memory card because of the design of a data memory card plug-in slot.

It will be apparent to those skilled in the art that various modifications and variations can be made to the structure of the present invention without departing from the scope or spirit of the invention. In view of the foregoing, it is intended that the present invention covers modifications and variations of this invention, provided they fall within the scope of the following claims and their equivalents

What is claimed is:

1. A computerized advertisement broadcasting system that uses the motion picture expert group (MPEG) technical conventions, comprising
a data memory card for storing an NPEG compressed bit stream; and
a console that includes a memory card plug-in slot for inserting the memory card, wherein the console also performs the function of drawing the MPEG compressed bit stream out from the memory card and then converting it into video signal output and left and right channel analogue audio signal output

2. The installation of claim 1, wherein the console further includes:
a microprocessor responsible for controlling operation of the whole system and the transfer of the MPEG compressed bit stream;
a signal bus coupled to the microprocessor and the memory card plug-in slot;
an MPEG decoder coupled to the signal bus responsible for decoding the MPEG compressed bit stream into digital video signals and a pulse code modulated audio signal,
a video coding device coupled to the MPEG decoder responsible for converting the digital video signals into video signals; and
an audio converter coupled to the MPEG decoder responsible for converting the pulse code modulated audio signal into analogue left and right channel audio signals.

3. The installation of claim 2, wherein the MPEG decoder further includes:
a first-in first-out buffer coupled to the signal bus for temporarily storing the MPEG compressed bit stream; and
a buffer capacity indicator coupled to the signal bus, giving relevant information to the microprocessor for controlling the quantity of transfer for MPEG compressed bit stream.

4. The installation of claim 2, wherein the video coding device is a device capable of coding digital video signals into TV composite signals

5. The installation of claim 2, wherein the video coding device is a device capable of coding digital video signals into S-video signals.

6. The installation of claim 2, wherein the video coding device is a device capable of coding digital video signals into analogue RGB signals

7. The installation of claim 2, wherein the console further includes a human-machine interface coupled to the signal bus for user control.

8. The installation of claim 7, wherein the human-machine interface includes a keyboard device.

9. The installation of claim 7, wherein the human-machine interface includes a remote control device

10. The installation of claim 10, wherein the human-machine interface includes a display screen control device.

11. The installation of claim 1, wherein the memory card plug-in slot includes a pin position detector coupled to the signal bus so that information regarding the inserting of a memory card or not can be detected and fed back to the microprocessor

12. The installation of claim 1, wherein the data memory card includes.
a memory card signal interface for coupling to the memory card plug-in slot once the memory card is plugged in; and
a non-volatile memory coupled to the memory card signal interface for storing the MPEG compressed bit stream.

13. The installation of claim 12, wherein the non-volatile memory residing in the data memory card is an erasable programmable read only memory (EPROM).

14. The installation of claim 12, wherein the non-volatile memory residing in the data memory card is an electrically erasable programmable read only memory (EEPROM)

15. The installation of claim 12, wherein the non-volatile memory residing in the data memory card is a flash memory.

16. The installation of claim 1, wherein the operation of the system comprises the steps of
switching on the console and executing the initialization instructions of the computerized advertisement broadcasting system;
checking whether a data memory card is inserted or not,
broadcasting pre-recorded program in the computerized advertisement broadcasting system, if a data memory card is not inserted; and
readjusting the internal parameters of the computerized advertisement broadcasting system, and broadcasting the advertising program stored in the MPEG compressed data stream format within the data memory card using a control program also stored inside the data memory card, if data memory card is inserted.

17. A computerized advertisement broadcasting system that uses the MPEG technical conventions, comprising:
a microprocessor responsible for controlling operation of the whole system and the transfer of MPEG compressed bit stream;
a signal bus coupled to the microprocessor;
a memory card plug-in slot coupled to the signal bus for inserting a data memory card;
a memory card capable of inserting into the memory card plug-in slot for storing the MPEG compressed bit stream,
an MPEG decoder coupled to the signal bus responsible for decoding the MPEG compressed bit stream into digital video signals and a pulse code modulated audio signal;
a video coding device coupled to the MPEG decoder responsible for converting the digital video signals into analogue video signals; and
an audio converter coupled to the MPEG decoder responsible for converting the pulse code modulated audio signal into analogue left and right channel audio signals.

18. The installation of claim 17, wherein the MPEG decoder further includes:
a first-in first-out buffer coupled to the signal bus for temporarily storing the MPEG compressed bit stream; and
a buffer capacity indicator coupled to the signal bus, giving relevant information to the microprocessor for controlling the quantity of transfer of MPEG compressed bit stream

19. The installation of claim 17, wherein the console further includes a human-machine interface coupled to the signal bus for user control

20. The installation of claim 19, wherein the human-machine interface includes a keyboard device.

21. The installation of claim 19, wherein the human-machine interface includes a remote control device

22. The installation of claim 19, wherein the human-machine interface includes a display screen control device.

23. The installation of claim 17, wherein the memory card plug-in slot includes a pin position detector coupled to the signal bus so that information regarding the inserting of a memory card or not can be detected and fed back to the microprocessor.

24. The installation of claim 17, wherein the data memory card includes:
a memory card signal interface for coupling to the memory card plug-in slot once the memory card is plugged in, and
a non-volatile memory coupled to the memory card signal interface for storing the MPEG compressed bit stream.

25. The installation of claim 24, wherein the non-volatile memory residing in the data memory card is an EPROM

26. The installation of claim 24, wherein the non-volatile memory residing in the data memory card is an EEPROM

27. The installation of claim 24, wherein the non-volatile memory residing in the data memory card is a flash memory
